(19) United States
(12) Patent Application Publication
(10) Pub. No.: US 2006/0269780 A1
(43) Pub. Date: Nov. 30, 2006

(54) Organic electroluminescent device

(76) Inventors: Takayuki Fukumatsu, Fukuoka (JP); Hiroshi Miyazaki, Fukuoka (JP)

Correspondence Address: BIRCH STEWART KOLASCH & BIRCH, PO BOX 747, FALLS CHURCH, VA, 22040-0747, US

(21) Appl. No.: 10/570,873

(22) PCT Filed: Sep. 15, 2004
(86) PCT No.: PCT/JP04/13532

§ 371 Date: Mar. 7, 2006

(30) Foreign Application Priority Data
Sep. 25, 2003 (JP) 2003-333629

(51) Int. Cl. B32B 19/00

(52) U.S. Cl. 428/690

(57) ABSTRACT

This invention provides an organic electroluminescent element (hereinafter referred to as an organic EL element) utilizing phosphorescence which shows improved luminous efficiency and assured driving stability and has a simple structure. The organic EL element comprises an anode, organic layers containing a hole-transporting layer, a lightemitting layer and an electron-transporting layer and a cathode piled one upon another on a substrate with the hole-transporting layer disposed between the light-emitting layer and the anode and the electron-transporting layer disposed between the light-emitting layer and the cathode. The light-emitting layer contains a pyridyl phenoxy zinc complex represented by the following general formula (I) as a host material and an organic metal complex containing at least one metal selected from Ru, Rh, Pd, Ag, Re, Os, Ir, Pt and Au as a guest material.

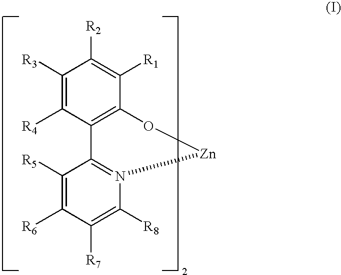

In formula (I), R₁—R₈ denote hydrogen and groups such as alkyl, alkenyl, cyano, amino, amide, alkoxycarbonyl, carboxyl, alkoxy and aryl.

### FIELD OF TECHNOLOGY

This invention relates to an organic electroluminescent element (hereinafter referred to as an organic EL element) and, more particularly, to a thin-film device which emits light when an electrical field is applied to its organic light-emitting layer.

### BACKGROUND TECHNOLOGY

In the development of electroluminescent elements utilizing organic materials, the kind of electrodes was optimized for the purpose of improving the electron-injecting efficiency from the electrode and an element in which a hole-transporting layer composed of an aromatic diamine and a light-emitting layer composed of 8-hydroxyquinoline aluminum complex (hereinafter referred to as Alq3) are disposed as thin films between the electrodes has been developed (Appl. Phys. Left., Vol. 51, p. 913, 1987) to bring about a noticeable improvement in luminous efficiency over the conventional elements utilizing single crystals of anthracene and the like. Following this, the developmental works of organic El elements have been focused on their commercial applications to high-performance flat panels characterized by self luminescence and high speed response.

In order to improve the efficiency of organic EL elements still further, various modifications of the aforementioned basic structure of anode/hole-transporting layer/light-emitting layer/cathode have been tried by suitably adding a hole-injecting layer, an electron-injecting layer and an electron-transporting layer. For example, the following structures are known: anode/hole-injecting layer/hole-trans porting layer/light-emitting layer/cathode; anode/hole-injecting layer/light-emitting layer/electron-transporting layer/cathode; anode/hole-injecting layer/light-emitting layer/electron-transporting layer/electron-injecting layer/cathode; anode/hole-injecting layer/hole-transporting layer/light-emitting layer/hole-blocking layer/electron-transporting layer/cathode. The hole-transporting layer has a function of transporting the holes injected from the hole-injecting layer to the light-emitting layer while the electron-transporting layer has a function of transporting the electrons injected from the cathode to the light-emitting layer. The hole-injecting layer is occasionally called an anode buffer layer.

The interposition of the hole-transporting layer between the light-emitting layer and the hole-injecting layer helps to inject more holes into the light-emitting layer by application of lower electrical field and, furthermore, the electrons injected into the light-emitting layer from the cathode or the electron-transporting layer accumulate in the interface between the hole-transporting layer and the light-emitting layer as the hole-transporting layer obstructs the flow of electrons. As a result, the luminous efficiency improves.

Likewise, the interposition of the electron-transporting layer between the light-emitting layer and the electron-injecting layer helps to inject more electrons into the light-emitting layer by application of lower electrical field and, furthermore, the holes injected into the light-emitting layer from the anode or the hole-transporting layer accumulate in the interface between the electron-transporting layer and the light-emitting layer as the electron-transporting layer obstructs the flow of holes. As a result, the luminous efficiency improves. A large number of organic materials conforming to the function of these layered structures have been developed.

The aforementioned element comprising the hole-transporting layer of an aromatic diamine and the light-emitting layer of Alq3 and many other elements utilize fluorescence. Now, the utilization of phosphorescence, that is, emission of light from the triplet excited state, is expected to raise the luminous efficiency approximately three times that of the conventional elements utilizing fluorescence (singlet). To achieve this end, studies had been conducted on the use of coumarin derivatives and benzophenone derivatives in the light-emitting layer, but the result was nothing but extremely low luminance. Thereafter, the use of europium complexes was attempted, but it was unable to obtain high luminous efficiency.

Recently, the possibility of emission of red light at high efficiency by the use of a platinum complex (PtOEP) has been reported (Nature, Vol. 395, p. 151, 1998). Thereafter, the efficiency of emission of green light has been improved markedly by doping the light-emitting layer with iridium complexes [Ir(ppy)3]. It is reported further that optimization of the light-emitting layer enables these iridium complexes to show extremely high luminous efficiency even when the structure of an element is simplified.

Regarding the chemical formulas of the aforementioned PtOEP, Ir(ppy)3 and the like, a reference should be made to the documents cited below. These documents additionally describe the structural formulas, abbreviations and so forth of the compounds generally used for host materials, guest materials and organic layers such as hole-injecting and electron-transporting layers. It is to be understood that the abbreviations used in the following description without an explanatory note are those commonly used in the technical field relating to organic EL elements and their meanings are described in the documents cited.

The prior documents relating to this invention are listed below.

Patent literature 1: JP2002-305083 A

Patent literature 2: JP2001-313178 A

Patent literature 3: JP2002-352957 A

Patent literature 4: JP2000-357588 A

Non-patent literature 1: C. Adachi et al., Appl. Phys. Left., 77, 904 (2000)

One of the compounds proposed as a host material in the development of phosphorescent organic electroluminescent elements is a carbazole compound CBP cited in the aforementioned patent literature 2. When CBP is used as a host material for tris(2-phenylpyridine)iridium complex (hereinafter referred to as Ir(ppy)3) which is a phosphorescent material emitting green light, the balanced injection of electrical charges is destroyed and holes existing in excess flow out to the electron-transporting side because CBP has a characteristic of facilitating the flow of holes and obstructing the flow of electrons. As a result, the luminous efficiency from Ir(ppy)3 drops.

As a means to solve the aforementioned problem, a hole-blocking layer is disposed between a light-emitting layer and an electron-transporting layer. The hole-blocking layer efficiently accumulates holes in the light-emitting layer and this helps to raise the probability of recombination of holes with electrons in the light-emitting layer to attain higher luminous efficiency. The hole-blocking materials currently in general use include 2,9-dimethyl-4,7-diphenyl-1,10-phenanthroline (hereinafter referred to as BCP) and p-phenylphenolato-bis(2-methyl-8-quinolinolato-N1,O8)aluminum (hereinafter referred to as BAlq).

There are useful host materials other than CBP and patent literature 1 discloses an organic EL element whose light-emitting layer comprises a complex (—Ar₁—Ar₂—O—)ₙ M composed of a group having both nitrogen-containing heterocyclic ring Ar₁ and an aromatic ring Ar₂ and a metal M as a host material and a noble metal complex as a guest material. A vast number of host materials are cited in this patent literature and one of them is a compound in which Ar₁ is a pyridine ring and Ar₂ is a benzene ring. Some are compounds in which M is Zn and n is 2 and this is the only example for M. A large number of metal complexes based on noble metals are cited as guest materials.

Patent literature 3 cites 3-phenyl-4-(1′-naphthyl)-5-phenyl-1,2,4-triazole (hereinafter referred to as TAZ) which is proposed as a host material for a phosphorescent organic electroluminescent element. As this compound has a characteristic of facilitating the flow of electrons and obstructing the flow of holes, the light-emitting range is on the side of the hole-transporting layer. In consequence, the luminous efficiency from Ir(ppy)3 may drop depending upon the affinity of Ir(ppy)3 with the material chosen for the hole-transporting layer. For example, 4,4′-bis(N-(1-naphthyl)-N-phenylamino)biphenyl (hereinafter referred to as NPB) is used most frequently as a hole-transporting layer because of its high performance, high reliability and long life; however, it shows poor affinity with Ir(ppy)3 and transition of energy occurs from TAZ to NPB thereby lowering the efficiency of transition of energy to Ir(ppy)3 and dropping the luminous efficiency.

As a means to solve the aforementioned problem, a material which does not cause transition of energy from Ir(ppy)3, for example, 4,4′-bis(N,N′-(3-toluyl)amino)-3,3′-dimethylbiphenyl (hereinafter referred to as HMTPD), is used as a hole-transporting layer.

It is reported in the aforementioned non-patent literature 1 that a phosphorescent electroluminescent element of a three-layer structure with the use of TAZ, 1,3-bis(N,N-t-butyl-phenyl)-1,3,4-oxazole (hereinafter referred to as OXD7) or BCP as the primary material and Ir(ppy)3 as a dopant in the light-emitting layer, Alq3 in the electron-transporting layer and HMTPD in the hole-transporting layer can emit light at high efficiency and, in particular, a system using TAZ performs excellently. However, HMTPD tends to crystallize easily as its Tg is approximately 50° C. and lacks reliability as an electroluminescent material. Thus, there are other problems such as extremely short life, difficulty of commercial application and high driving voltage.

Patent literature 4 describes organic EL elements using metal complexes such as bis(2-phenoxy-2-pyridyl)zinc, but they do not utilize phosphorescence.

### DISCLOSURE OF THE INVENTION

### Problems to be Solved by the Invention

In applying organic El elements to display devices such as flat panel displays, it is necessary to improve the luminous efficiency of elements and at the same time to secure the driving stability. In view of the aforementioned present conditions, an object of this invention is to provide a practically useful organic El element which performs with high efficiency and long life and has a simple structure.

### Means to Solve the problems

This invention relates to an organic electroluminescent element comprising an anode, organic layers containing a hole-transporting layer, a light-emitting layer and an electron-transporting layer and a cathode piled one upon another on a substrate with the hole-transporting layer disposed between the light-emitting layer and the anode and the electron-transporting layer disposed between the light-emitting layer and the cathode wherein the light-emitting layer contains a compound represented by the following general formula (I) as a host material and an organic metal complex containing at least one metal selected from ruthenium, rhodium, palladium, silver, rhenium, osmium, iridium, platinum and gold as a guest material.

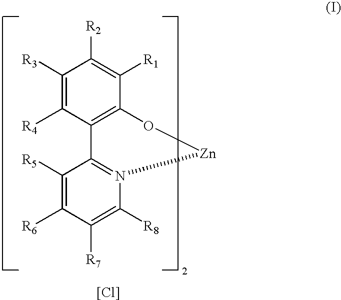

In general formula (I), R₁—R₈ are independently hydrogen, alkyl groups, aralkyl groups, alkenyl groups, cyano groups, amino groups, amide groups, alkoxycarbonyl groups, carboxyl groups, alkoxy groups, substituted or unsubstituted aromatic hydrocarbon groups or substituted or unsubstituted aromatic heterocyclic groups.

An organic EL element of better quality, can be obtained when the hole-transporting layer comprises a triarylamine dimer having at least two aryl groups of a condensed ring structure represented by the following general formula (II).

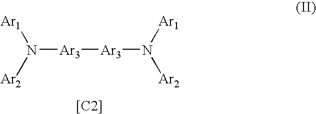

In general formula (II), Ar₁ and Ar₂ are monovalent aromatic groups of 6-14 carbon atoms, at least one of Ar₁ and Ar₂ is an aromatic group of 10-14 carbon atoms having a condensed ring structure and Ar₃ is a divalent aromatic group of 6-14 carbon atoms.

Furthermore, a desirable organic EL element can be obtained when the guest material is phosphorescent tris(2-phenylpyridine)iridium complex emitting green light.

An organic El element obtained according to this invention has a light-emitting layer comprising a compound represented by the general formula (I) and a phosphorescent organic metal complex containing at least one metal selected from groups 7-11 of the periodic table, that is, it is an organic EL element utilizing phosphorescence. The light-emitting layer contains a compound represented by general formula (I) as the primary component and an organic metal complex containing at least one metal selected from ruthenium, rhodium, palladium, silver, rhenium, osmium, iridium, platinum and gold as the secondary component.

The primary component here means the component which accounts for 50 wt % or more of the materials constituting the layer in question while the secondary component means the component which accounts for less than 50 wt % of the materials constituting the layer in question. In the organic EL element of this invention, the compound represented by general formula (I) in the light-emitting layer is basically required to have an excited triplet level higher in energy than that of the phosphorescent organic metal complex contained in said light-emitting layer. Moreover, this compound must yield a thin film of stable shape and/or have a high glass transition temperature (Tg) and transport holes and/or electrons. Still more, the compound must be electrochemically and chemically stable and rarely generate impurities during manufacture or use which become traps or quench the emitted light.

Furthermore, in order to reduce the influence of the excited triplet level of the hole-transporting layer on the emission of light from the phosphorescent organic complex, it is important for the compound to have a hole-injecting ability to keep the range of emission of light at a suitable distance from the interface of the hole-transporting layer.

As a material for forming a light-emitting layer capable of satisfying these conditions, this invention uses a compound represented by the aforementioned formula (I) as a host material. In general formula (I), R₁—R₈ are independently hydrogen atoms, alkyl, aralkyl, alkenyl, cyano, amino, amide, alkoxycarbonyl, carboxyl, alkoxy, substituted or unsubstituted aromatic hydrocarbon groups or substituted or unsubstituted aromatic heterocyclic groups. Preferred examples of these groups are alkyl of 1-6 carbon atoms (hereinafter referred to as lower alkyl), aralkyl (typically, benzyl and phenetyl groups), alkenyl of 1-6 carbon atoms, amino represented by —NR₂ (R is hydrogen or lower alkyl), amido represented by —CONH₂ and alkoxycarbonyl and alkoxy derived from alcohols of 1-6 carbon atoms.

Preferred examples of aromatic hydrocarbon groups are phenyl, naphthyl, acenaphthyl and anthryl and preferred examples of aromatic heterocyclic groups are pyridyl, quinolyl, thienyl, carbazolyl, indolyl and furyl. When these aromatic hydrocarbon groups and aromatic heterocyclic groups are substituted, the substituent groups include lower alkyl, lower alkoxy, phenoxy, tolyloxy, benzyloxy, phenyl, naphthyl and dimethylamino groups.

In choosing a compound represented by general formula (I), R₁—R₈ are preferably hydrogen atoms, lower alkyl, lower alkoxy or aromatic hydrocarbon groups of 1-10 carbon atoms. More preferably, six or more of R₁—R₈ are hydrogen atoms and others are lower alkyl groups and, most preferably, R₁—R₈ are all hydrogen atoms.

A compound represented by general formula (I) is synthesized by the complex-forming reaction of a zinc salt with a compound represented by general formula (III). The groups R₁—R₈ in general formula (III) correspond to the groups R₁—R₈ in general formula (I).

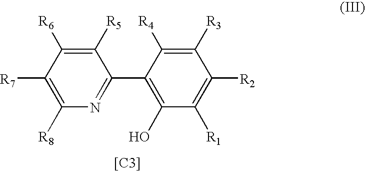

Compounds represented by the general formula (I) desirable for use in this invention are listed below, but they are not limited to these examples.

TABLE 1

| Compound | | | | | | | | |
|---|---|---|---|---|---|---|---|---|
| number | R1 | R2 | R3 | R4 | R5 | R6 | R7 | R8 |
| 1 | H | H | H | H | H | H | H | H |
| 2 | Me | H | H | H | H | H | H | H |
| 3 | t-Bu | H | t-Bu | H | H | H | H | H |
| 4 | t-Bu | H | t-Bu | H | H | H | CF3 | H |
| 5 | Ph | H | H | H | H | H | H | H |
| 6 | NO2 | H | H | H | H | H | H | H |
| 7 | NO2 | H | NO2 | H | H | H | H | H |
| 8 | NO2 | H | NO2 | H | H | H | OMe | H |
| 9 | NO2 | H | NO2 | H | H | H | OPh | H |
| 10 | N(Me)2 | H | H | H | H | H | H | H |
| 11 | N(Me)2 | H | N(Me)2 | H | H | H | H | H |
| 12 | CF3 | H | H | H | H | H | H | H |
| 13 | H | Me | H | H | H | H | H | H |
| 14 | H | t-Bu | H | t-Bu | H | H | H | H |
| 15 | H | t-Bu | H | t-Bu | Me | H | H | H |
| 16 | H | Ph | H | H | H | H | H | H |
| 17 | H | OMe | H | H | H | H | H | H |
| 18 | H | OPh | H | H | H | H | H | H |
| 19 | H | NO2 | H | H | H | H | H | H |
| 20 | H | N(Me)2 | H | H | H | H | H | H |
| 21 | H | H | OMe | H | H | H | H | H |
| 22 | H | H | OPh | H | H | H | H | H |
| 23 | H | H | NO2 | H | H | H | H | H |
| 24 | H | H | NO2 | H | Me | H | H | H |
| 25 | H | H | NO2 | H | Ph | H | H | H |

TABLE 2

| Compound | | | | | | | | |
|---|---|---|---|---|---|---|---|---|
| number | R1 | R2 | R3 | R4 | R5 | R6 | R7 | R8 |
| 26 | H | H | NO2 | H | H | OMe | H | H |
| 27 | H | H | NO2 | H | H | OPh | H | H |
| 28 | H | H | NO2 | H | H | Me | H | H |
| 29 | H | H | NO2 | H | H | Ph | H | H |
| 30 | H | H | N(Me)2 | H | H | H | H | H |
| 31 | H | H | CF3 | H | H | H | H | H |
| 32 | H | H | CN | H | H | H | H | H |
| 33 | H | H | CN | H | Me | H | H | H |
| 34 | H | H | CN | H | Ph | H | H | H |
| 35 | H | H | F | H | H | H | H | H |
| 36 | H | H | NHCOMe | H | H | H | H | H |
| 37 | H | H | NHCOPh | H | H | H | H | H |
| 38 | H | H | OCOEt | H | H | H | H | H |
| 39 | H | H | OCOPh | H | H | H | H | H |
| 40 | H | H | H | n-Bu | H | H | H | H |
| 41 | H | H | H | Ph | H | H | H | H |
| 42 | H | H | H | OMe | H | H | H | H |
| 43 | H | H | H | OPh | H | H | H | H |
| 44 | H | H | H | H | Me | H | H | H |
| 45 | H | H | H | H | Et | H | Me | H |
| 46 | H | H | H | H | Ph | H | H | H |
| 47 | H | H | H | H | OMe | H | H | H |
| 48 | H | H | H | H | OPh | H | H | H |
| 49 | H | H | H | H | H | Me | H | H |
| 50 | H | H | H | H | H | t-Bu | H | H |
| 51 | H | H | H | H | H | Ph | H | H |
| 52 | H | H | H | H | H | OMe | H | H |
| 53 | H | H | H | H | H | OPh | H | H |

TABLE 3

| Compound | | | | | | | | |
|---|---|---|---|---|---|---|---|---|
| number | R1 | R2 | R3 | R4 | R5 | R6 | R7 | R8 |
| 54 | H | H | H | H | H | CN | H | H |
| 55 | H | H | H | H | H | H | H | Me |
| 56 | H | H | H | H | H | H | H | Ph |
| 57 | H | H | H | H | H | H | H | CN |
| 58 | H | H | H | H | H | H | H | COOMe |
| 59 | H | H | H | H | H | H | H | CH₂N(Et)₂ |

A guest material in the light-emitting layer comprises an organic metal complex containing at least one metal selected from ruthenium, rhodium, palladium, silver, rhenium, osmium, iridium, platinum and gold. Organic metal complexes of this kind are publicly known in the aforementioned patent literature and other documents and a suitable compound can be selected from such known compounds and used.

Desirable organic metal complexes are of the type of compound represented by the following general formula (IV).

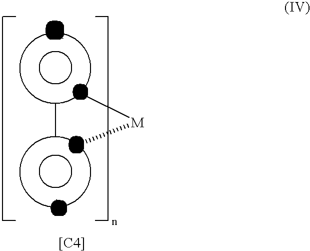

In this formula, M denotes any one of the aforementioned metals and n is the valence of said metal.

The ring A, denotes substituted or unsubstituted aromatic hydrocarbon or aromatic heterocyclic group, preferably phenyl, biphenylyl, napthyl, anthryl, tienyl, pyridyl, quinolyl or isoquinolyl group. These groups may have the following substituents; halogens such as fluorine, alkyl of 1-6 carbon atoms such as methyl and ethyl, alkenyl of 2-6 carbon atoms such as vinyl group, alkoxycarbonyl of 2-6 carbon atoms such as methoxycarbonyl and ethoxycarbonyl, alkoxy of 1-6 carbon atoms such as methoxy and ethoxy, aryloxy such as phenoxy and benzyloxy, dialkylamino such as dimethylamino and diethylamino, acyl such as acetyl, haloalkyl such as trifluoromethyl and cyano.

The ring A₂ denotes a nitrogen-containing aromatic heterocyclic group and may have substituents which are preferably pyridyl, pyrimidyl, pyrazinyl, triazinyl, benzothiazolyl, benzoxazolyl, benzimidazolyl, quinolyl, isoquinolyl, quinoxalinyl and phenathridinyl groups.

These aromatic heterocyclic groups may have the following substituents; halogens such as fluorine, alkyl of 1-6 carbon atoms such as methyl and ethyl, alkenyl of 2-6 carbon atoms such as vinyl, alkoxycarbonyl of 2-6 carbon atoms such as methoxycarbonyl and ethoxycarbonyl, alkoxy of 1-6 carbon atoms such as methoxy and ethoxy, aryloxy such as phenoxy and benzyloxy, dialkylamino groups such as dimethylamino and diethylamino, acyl groups such as acetyl, haloalkyl such as trifluoromethyl and cyano.

A substituent on the ring A, and a substituent on the ring A₂ may link together to form a condensed ring and an example of such a case is 7,8-benzoquinoline. Preferred substituents on the rings A₁ and A₂ are alkyl, alkoxy, aromatic hydrocarbon groups and cyano. In general formula (IV), a metal denoted by M is preferably selected from ruthenium, rhodium, palladium, silver, rhenium, osmium, iridium, platinum and gold. Organic metal complexes represented by the aforementioned general formula (IV) are listed below, but are not limited to these examples.

Among the compounds listed, phosphorescent tris(2-phenylpyridine)iridium complex emitting green light or the compound designated as D-1 is preferred.

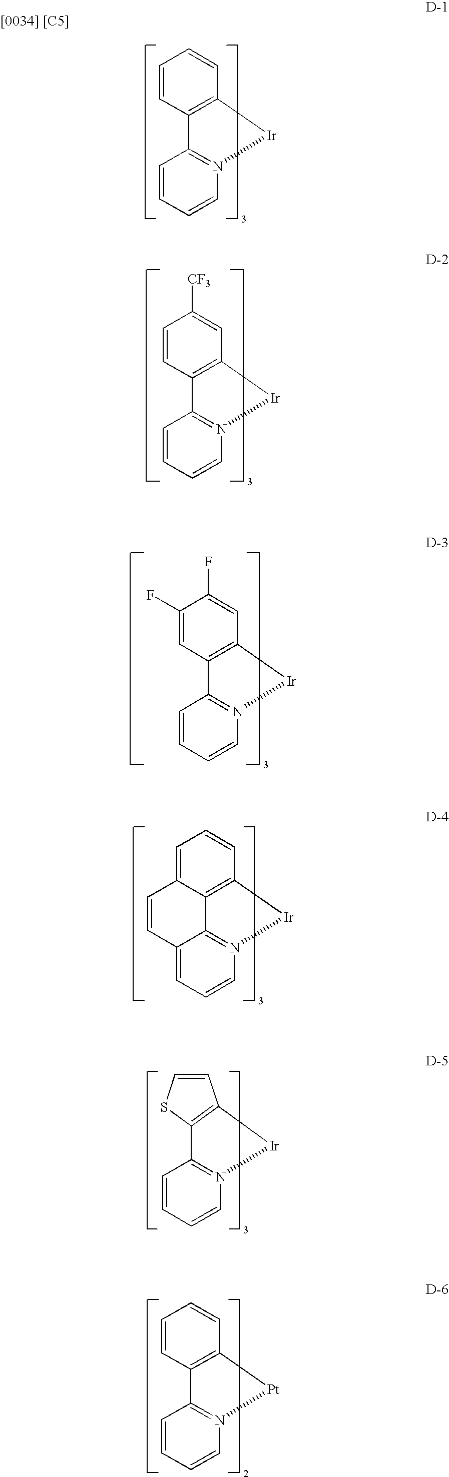

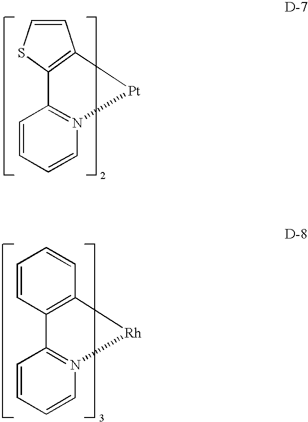

According to this invention, an organic EL element has a hole-transporting layer which is disposed between a light-emitting layer and an anode. The hole-transporting layer comprises a hole-transporting material which preferably contains a triarylamine dimer having at least two aryl groups of a condensed ring structure. The triarylamine dimer means a compound represented by (—Ar—NAr₂)₂ and Ar here denotes an aryl or arylene group.

A compound preferable as such triarylamine dimer is represented by the aforementioned general formula (II). In general formula (II), Ar₁ and Ar₂ are monovalent aromatic group of 6-14 carbon atoms and at least one of Ar₁ and Ar₂ is an aromatic group of 10-14 carbon atoms having a condensed ring structure. Aromatic groups of a condensed ring structure are preferably aromatic groups having a ring formed by condensation of 2-3 rings such as naphthyl and lower alkyl-substituted naphthyl. Aromatic groups other than those of a condensed ring structure preferably have a benzene ring in them such as phenyl, lower alkyl-substituted phenyl and biphenylyl. The group Ar₃ is a divalent aromatic group of 6-14 carbon atoms and preferred examples are phenylene and lower alkyl-substituted phenylene.

Of triarylamine dimers, NPB and 4,4′-bis(N-(9-phenanthryl)-N-phenylamino)biphenyl (hereinafter referred to as PPB) are preferred.

A host material to be used in the light-emitting layer according to this invention is capable of letting electrons and holes flow nearly uniformly and allows light to emit in the center of the light-emitting layer. In consequence, it is possible to use highly reliable materials, for example, NPB in the hole-transporting layer and Alq3 in the electron-transporting layer, unlike the case of TAZ where light emits on the side of the hole-transporting layer and transition of energy occurs into the hole-transporting layer thereby lowering the efficiency or the case of CPB where light emits on the side of the electron-transporting layer and transition of energy occurs into the electron-transporting layer thereby lowering the efficiency.

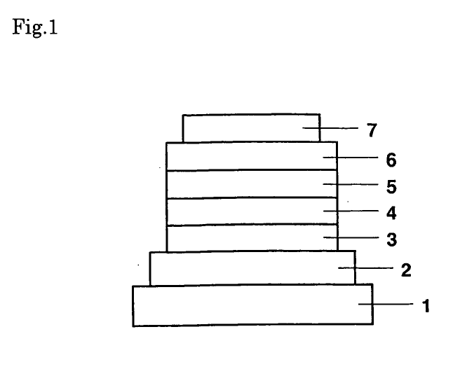

### BRIEF DESCRIPTION OF THE DRAWING

[FIG. 1] A schematic cross section illustrating an example of organic. electroluminescent element.

### NUMBERING IN THE DRAWING

1, substrate; 2, anode; 3, hole-injecting layer; 4, hole-transporting layer; 5, light-emitting layer; 6, electron-transporting layer; 7, cathode.

### PREFERRED EMBODIMENTS OF THE INVENTION

An organic EL element of this invention will be described with reference to the drawing. In FIG. 1 is schematically illustrated the cross section of a structure generally used for an organic EL element. In FIG. 1, a substrate is designated as 1, an anode as 2, a hole-injecting layer as 3, a hole-transporting layer as 4, a light-emitting layer as 5, an electron-transporting layer as 6 and a cathode as 7. According to this invention, it is essential for an organic EL element to have layers comprising a substrate, an anode, a hole-transporting layer, a light-emitting layer, an electron-transporting layer and a cathode; however, it is possible to omit layers other than these essential ones, for example, a hole-injecting layer and it is allowable to add another layer if necessary. It is allowable to add a hole-blocking layer to an organic EL element of this invention, but the layered structure would be simplified to gain advantages in manufacture and performance if a hole-blocking layer were not added.

The substrate 1 supports an organic EL element and is made from a quartz or glass plate, a metal plate or foil or a plastic film or sheet. In particular, transparent sheets of synthetic resins such as polyester, polymethacrylate, polycarbonate and polystyrene are desirable. When a synthetic resin is used for a substrate, it is necessary to take the gas barrier property of the resin into consideration. There is an undesirable possibility of the air passing through a substrate to degrade an organic EL element when the gas barrier property of the substrate is too poor. One of the remedial methods is to provide a dense silicon oxide film on at least one side of the synthetic resin substrate to secure the necessary gas barrier property.

The anode 2 is provided on the substrate 1 and plays a role of injecting holes into the hole-transporting layer. The anode is usually constructed of a metal such as aluminum, gold, silver, nickel, palladium and platinum, a metal oxide such as oxide of indium and/or fin, a metal halide such as copper iodide, carbon black and conductive polymers such as poly(3-methylthiophene), polypyrrole and polyaniline. The anode is usually formed by a technique such as sputtering and vacuum deposition. Where fine particles of a metal such as silver, copper iodide, carbon black, conductive metal oxides or conductive polymers are used, the particles are dispersed in a solution of a binder resin and applied to the substrate 1 to form the anode 2. Moreover, in the case of a conductive polymer, it is possible to form the anode 2 by directly forming a thin film of the conductive polymer on the substrate 1 by electrolytic polymerization of the corresponding monomer or by coating the substrate 1 with the conductive polymer. The anode may be formed by piling different materials one upon another. The anode varies in thickness with the requirement for transparency. Where transparency is needed, it is preferable to keep the transmittance of visible light usually at 60% or more, preferably at 80% or more. In this case, the thickness is usually 5-1000 nm, preferably 10-500 nm. Where opaqueness is acceptable, the anode 2 may be the same as the substrate 1. Further, it is possible to laminate a different conductive material on the aforementioned anode 2.

The hole-transporting layer 4 is provided on the anode 2. The hole-injecting layer 3 may be provided between the hole-transporting layer and the anode. The material selected for the hole-transporting layer must inject holes from the anode efficiently and transport the injected holes efficiently. To satisfy this requirement, the material in question must have a low ionization potential, be highly transparent against visible light, show high hole mobility, show excellent stability and rarely generate impurities during manufacture or use which become traps. Still more, as the hole-transporting layer exists in contact with the light-emitting layer 5, it must not quench the light from the light-emitting layer nor form exciplexes between the light-emitting layer to lower the efficiency. Besides the aforementioned general requirements, heat resistance is additionally required where application of organic El elements to vehicular displays is considered. Therefore, the material preferably has a Tg of 85° C. or more.

According to this invention, it is preferable to use the aforementioned triarylamine dimer such as NPB and PPB as a hole-transporting material in an organic EL element.

If necessary, it is allowable to use another publicly known compound as a hole-transporting material together with a triarylamine dimer. Such compounds include aromatic diamines containing two tertiary amines whose nitrogen atoms are substituted with two or more aromatic condensed rings, aromatic amines of a starburst structure such as 4,4′,4″-tris(1-naphthylphenylamino)triphenylamine, an aromatic amine consisting of a tetramer of triphenylamine and spiro compounds such as 2,2′,7,7″-tetrakis-(diphenylamino)-9,9′-spirobifluorene. These compounds may be used singly or, if necessary, as a mixture.

Besides the aforementioned compounds, the materials useful for the hole-transporting layer include polymeric materials such as polyvinylcarbazole, polyvinyltriphenylamine and polyaryleneethersulfones containing tetraphenylbenzidine.

When the coating process is used in forming the hole-transporting layer, a coating solution is prepared by mixing one kind or more of hole-transporting materials and, if necessary, binder resins which do not become traps of holes and additives such as improvers of coating properties, the solution is applied to the anode 2 by a process such as spin coating and the solution is dried to form the hole-transporting layer 4. The binder resins here include polycarbonate, polyarylate and polyester. Addition of a binder resin in a large amount lowers the hole mobility and it is preferably kept at a lower level, usually, below 50 wt %.

When the vacuum deposition process is used in forming the hole-transporting layer, the selected hole-transporting material is introduced to a crucible placed in a vacuum vessel, the vessel is evacuated to 1×10⁻⁴ Pa or so by a suitable vacuum pump, the crucible is heated to evaporate the hole-transporting material and the hole-transporting layer 4 is formed on the substrate which is placed opposite the crucible and on which an anode has been formed. The thickness of the hole-transporting layer 4 is usually 5-300 nm, preferably 10-100 nm. The vacuum deposition process is generally used to form such a thin film uniformly.

The light-emitting layer 5 is provided on the hole-transporting layer 4. The light-emitting layer 5 comprises a compound represented by the aforementioned general formula (I) and an organic metal complex containing a metal selected from groups 7-11 of the periodic table. On application of an electrical field between the electrodes, the holes injected from the anode and migrating through the hole-transporting layer recombine with the electrons injected from the cathode and migrating through the electron-transporting layer 6 to excite the light-emitting layer thereby causing intense luminescence. The light-emitting layer 5 may contain other components, for example, other host materials (acting in the same way as a compound represented by general formula (I)) and fluorescent colorants to the extent that they do not damage the performance of this invention.

The content of the aforementioned organic metal complex in the light-emitting layer is preferably in the range of 0.1-30 wt %. A content of less than 0.1 wt % does not contribute to improvement of the luminous efficiency of an element while a content in excess of 30 wt % causes quenching of light due to change in concentration caused by dimerization of molecules of the organic metal complex and results in lowering of the luminous efficiency. In the conventional elements utilizing fluorescence (singlet), it is a desirable tendency for an organic metal complex to be in an amount somewhat larger than that of a fluorescent colorant (dopant) contained in the light-emitting layer. The organic metal complex may be contained partially or distributed nonuniformly in the direction of film thickness in the light-emitting layer.

The thickness of the light-emitting layer 5 is usually 10-200 nm, preferably 20-100 nm. The light-emitting layer is formed in thin film in the same way as the hole-transporting layer 4.

In order to improve further the luminous efficiency of an element, the electron-transporting layer 6 is provided between the light-emitting layer 5 and the cathode 7. The electron-transporting layer 6 is made from a compound which is capable of efficiently transporting the electrons injected from the cathode towards the light-emitting layer 5 upon application of an electrical field between the electrodes. An electron-transporting compound to be used in the electron-transporting layer 6 must be a compound which efficiently injects electrons from the cathode 7, shows high hole mobility and efficiently transports the injected electrons.

The electron-transporting materials satisfying the aforementioned conditions include metal complexes such as Alq3, 10-hydroxybenzo[h]quinoline metal complexes, oxadiazole derivatives, distyrylbiphenyl derivatives, silole derivatives, 3- or 5-hydroxyflavone metal complexes, benzoxazole metal complexes, benzothiazole metal complexes, trisbenzimidazolylbenzene, quinoxaline compounds, phenanthroline derivatives, 2-t-butyl-9,10-N,N′-dicyanoanthraquinonediimine, n-type hydrogenated amorphous silicon carbide, n-type zinc sulfide and n-type zinc selenide. The thickness of the electron-transporting layer 6 is usually 5-200 nm, preferably 10-100 nm.

The electron-transporting layer 6 is formed on the light-emitting layer 5 by the coating or vacuum deposition process as in the case of the hole-transporting layer 4. The vacuum deposition process is normally used.

The electron-transporting layer 6 is put upon the light-emitting layer 5 and it is allowable to put a hole-blocking layer between the two.

The interposition of the hole-injecting layer 3 between the hole-transporting layer 4 and the anode 2 is also practiced for the purpose of enhancing the efficiency of hole injection and improving the adhesive strength of the organic layer as a whole to the anode. The interposition of the hole-injecting layer 3 is effective for lowering the initial driving voltage of an element and at the same time suppressing a rise in voltage when an element is driven continuously at constant current density. A material to be used for the hole-injecting layer must satisfy the following requirements; it closely contacts the anode, it can be formed into a thin film uniformly and it is thermally stable, that is, it has a melting point of 300° C. or above and a glass transition temperature of 100° C. or above. Furthermore, the material in question must have a low ionization potential, facilitate the injection of holes from the anode and show high hole mobility.

The materials reported to be capable of attaining this object include phthalocyanine compounds such as copper phthalocyanine, organic compounds such as polyaniline and polythiophene, sputtered carbon membranes and metal oxides such as vanadium oxide, ruthenium oxide and molybdenum oxide. The hole-injecting layer can be formed in thin film as in the case of the hole-transporting layer and, in the case of inorganic materials, the processes such as sputtering, electron beam deposition and plasma CVD are additionally used. The thickness of the anode buffer layer 3 thus formed is usually 3-100 nm, preferably 5-50 nm.

The cathode 7 plays a role of injecting electrons into the light-emitting layer 5. A material to be used for the cathode may be the same as that used for the aforementioned anode 2, but a metal with low work function is used preferably as it efficiently injects electrons. Examples of such metals are tin, magnesium, indium, calcium, aluminum, silver and their alloys. Concretely, electrodes made from alloys of low work function such as magnesium-silver alloy, magnesium-indium alloy and aluminum-lithium alloy are cited.

The thickness of the cathode 7 is usually the same as that of the anode 2. To protect a cathode made from a metal of low work function, the cathode is covered with a layer of a metal of high work function which is stable in the air thereby increasing the stability of an element. The metals suitable for attaining the object include aluminum, silver, copper, nickel, chromium, gold and platinum. Furthermore, the interposition of an ultrathin insulating film (0.1-5 nm) of LiF, MgF₂, Li₂O and the like between the cathode and the electron-transporting layer provides another effective means to improve the efficiency of an element.

It is possible to obtain a structure which is the reverse of the structure shown in FIG. 1 by piling one upon another the cathode 7, the electron-transporting layer 6, the light-emitting layer 5, the hole-transporting layer 4 and the anode 2 in this order on the substrate 1. As was described earlier, it is also possible to provide an organic EL element of this invention between two substrates at least one of which is highly transparent. In this case, it is also possible to add or omit layers if necessary.

An organic El element obtained according to this invention can be applied to a single element, an element having a structure arranged in array or an element having a structure with the anode and the cathode arranged in X-Y matrix. The organic EL element is so constructed as to comprise a compound of specified skeleton and a phosphorescent organic complex in its light-emitting layer in order to realize higher luminous efficiency and better driving stability than the conventional elements utilizing emission of light from the singlet state and it performs excellently in applications to full-color or multicolor panels.

### EXAMPLES

This invention will be described in detail below with reference to Synthetic Examples and Examples, but will not be limited to the description in these examples unless it exceeds the substance of this invention.

### Synthetic Example 1

In 60 ml of methanol were dissolved 1.6 g of zinc acetate dihydrate and 1.4 g of triethylamine. To the solution was added slowly in drops a solution of 2.4 g of 2-(2-hydroxyphenyl)pyridine in 20 ml of methanol and the mixture was stirred at room temperature for 4 hours. The precipitate was collected by filtration, washed with methanol and then dried under reduced pressure to give 1.6 g of a pale yellow powder. This product was 2-(2-hydroxyphenyl)pyridine zinc complex (hereinafter referred to as Zn(PhPy)2) or a compound represented by general formula (I) in which R₁—R₈ are all hydrogen atoms and a portion of this product was purified by sublimation and used in the preparation of an element.

The starting material 2-(2-hydroxyphenyl)pyridine was synthesized according to the method described in JP2000-357588 A.

### Supplementary Example 1

On a glass substrate was vacuum-deposited Zn(PhPy)2, TAZ, bis(8-hydroxyquinolinolato)zinc (hereinafter referred to as Znq2) or Alq3 at a vacuum of 4.0×10⁻⁴ Pa at a rate of 1.0 Å/s. Each specimen was left standing in the air at room temperature and the time until start of crystallization was measured to examine the stability of thin film. The results are shown in Table 4.

TABLE 4

| | Number of days to crystallization |
|---|---|
| TAZ | 2-3 days or less |
| Zn(PhPy)2 | 30 days or more |
| Znq2 | 30 days or more |
| Alq3 | 30 days or more |

### Supplementary Example 2

A light-emitting layer alone was vacuum-deposited on a glass substrate to study the suitability of Ir(ppy)3 as a host material.

On a glass substrate were co-vacuum-deposited Zn(PhPy)2 and Ir(ppy)3 from different evaporation sources at a vacuum of 4.0×10⁻⁴ Pa to form a thin film with a thickness of 500 Å containing 7.0% of Ir(ppyy)3. Likewise, thin films were formed by changing the primary component from Zn(PhPy)2 to TAZ, Znq2 or Alq3.

The thin film thus formed was evaluated by an apparatus for measuring fluorescence. The excitation wavelength is the maximum absorption wavelength of Zn(PhPy)2, TAZ, Znq2 or Alq3 and the light emitted at this wavelength was observed. The results are shown in Table 5.

TABLE 5

| | Luminescence | Luminescence |
|---|---|---|
| | from Ir(ppy)3 | from host |
| TAZ | ∘ | x |
| Zn(PhPy)2 | ∘ | x |
| Znq2 | x | ∘ |
| Alq3 | x | ∘ |

When TAZ or Zn(PhPy)2 is used as the primary material for the light-emitting layer, transition of energy occurs to Ir(ppy)3 causing Ir(ppy)3 to phosphoresce. On the other hand, when Znq2 or Alq3 is used, transition of energy does not occur to Ir(ppy)3 and Znq2 or Alq3 itself fluoresces.

### Example 1

An organic EL element was prepared by omitting a hole-injecting layer from and adding an electron-injecting layer to the structure shown in FIG. 1. An ITO anode was formed on a glass substrate to a film thickness of 150 nm and on this glass substrate were formed other constituent layers one upon another by vacuum deposition at 4.0×10⁻⁴ Pa. First, NPB as a hole-transporting layer was vacuum-deposited on the ITO anode at a rate of 1.0 Å/s to a thickness of 600 Å.

Then, Zn(PhPy)2 and Ir(ppy)₃ as a light-emitting layer were co-vacuum-deposited on the hole-transporting layer from different evaporation sources at a rate of 1.0 Å/s to a thickness of 250 Å. The concentration of Ir(ppy)3 at this point was 7.0%. After this, Alq3 as an electron-transporting layer was vacuum-deposited at a rate of 1.0 Å/s to a thickness of 500 Å. Further, lithium fluoride (LiF) as an electron-injecting layer was vacuum-deposited on the electron-transporting layer at a rate of 0.5 Å/s to a thickness of 5 Å. Finally, aluminum as an electrode was vacuum-deposited on the electron-injecting layer at a rate of 15 Å/s to a thickness of 1700 Å to give an organic EL element.

The organic EL element thus obtained was connected to an external power source and, when direct current voltage was applied, showed the light-emitting characteristics shown in Table 6. In Table 6, the values of the luminance, voltage and luminous efficiency are those at a current density of 10 mA/cm². The maximum wavelength of the spectrum observed in emission of light from the element is 517 nm and this indicates that Ir(pyy)3 emits light.

### Example 2

An organic EL element was prepared as in Example 1 with the exception of using HMTPD as the primary component of the light-emitting layer.

### Comparative Example 1

An organic EL element was prepared as in Example 1 with the exception of using TAZ as the primary component of the light-emitting layer.

### Comparative Example 2

Referring to FIG. 1, thin films constituting respective layers were vacuum-deposited on a glass substrate with an ITO anode formed on its surface at 4.0×10⁻⁴ Pa. First, copper phthalocyanine (CuPc) as a hole-injecting layer was vacuum-deposited on the ITO anode at a rate of 1.0 Å/s to a thickness of 250 Å. Then, NPB as a hole-transporting layer was vacuum-deposited at a rate of 1.0 Å/s to a thickness of 450 Å.

Following this, Alq3 as both light-emitting layer and electron-transporting layer was deposited on the hole-transporting layer at a rate of 1.0 Å/s to a thickness of 600 Å. Further, lithium fluoride (LiF) as an electron-injecting layer was vacuum-deposited on the electron-transporting layer at a rate of 0.5 Å/s to a thickness of 5 Å. Finally, aluminum (Al) as an electrode was vacuum-deposited on the electron-injecting layer at a rate of 15 Å/s to a thickness of 1700 Å to form an organic EL element. The results are shown in Table 6.

TABLE 6

| | Luminance | Voltage | Luminous efficiency |
|---|---|---|---|
| | (cd/m²) | (V) | (lm/W) |
| Example 1 | 1320 | 8.2 | 5.1 |
| Example 2 | 1710 | 12.6 | 4.3 |
| Comp. ex. 1 | 1270 | 9.5 | 4.2 |
| Comp. ex. 2 | 347 | 9.7 | 1.1 |

### INDUSTRIAL APPLICABILITY

This invention has made it possible to obtain not only an organic electroluminescent element which emits light of high luminance efficiently at low voltage but also an element which degrades little when stored at high temperatures. Thus, this organic electroluminescent element is highly valuable technically because of its potential applicability to flat panel displays (for example, office computers and wall-hanging television sets), vehicular display devices, cellular phone displays, light sources utilizing a characteristic property of the element to emit light from the whole surface (for example, light source of a copier and backlight source of liquid crystal displays and instruments), display boards and marking lamps.

What is claimed is:

1. An organic electroluminescent element comprising an anode, organic layers containing a hole-transporting layer, a light-emitting layer and an electron-transporting layer and a cathode piled one upon another on a substrate with the hole-transporting layer disposed between the light-emitting layer and the anode and the electron-transporting layer disposed between the light-emitting layer and the cathode wherein the lightemitting layer contains a compound represented by the following general formula (I) as a host material and an organic metal complex containing at least one metal selected from ruthenium, rhodium, palladium, silver, rhenium, osmium, iridium, platinum and gold as a guest material: 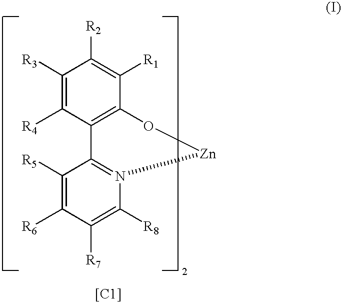
in general formula (I), R₁—R₈ are independently hydrogen atoms, alkyl, aralkyl, alkenyl, cyano, amino, amide, alkoxycarbonyl, carboxyl, alkoxy, substituted or unsubstituted aromatic hydrocarbon groups or substituted or unsubstituted aromatic heterocyclic groups.

2. An organic electroluminescent element as described in claim 1 wherein the hole-transporting layer contains a triarylamine dimer having at least 2 aryl groups of a condensed ring structure and the triarylamine dimer is represented by the following general formula (II) 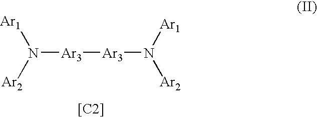
in which Ar₁ and Ar₂ are aromatic groups of 614 carbon atoms, at least one of Ar₁ and Ar₂ is an aromatic group of 10-14 carbon atoms having a condensed ring structure and Ar₃ is a divalent aromatic group of 6-14 carbon atoms.

3. An organic electroluminescent element as described in claim 1 or 2 wherein the guest material is phosphorescent tris(2-phenylpyridine)iridium complex emitting green light.
